(19) United States
(12) Patent Application Publication
(10) Pub. No.: US 2014/0196036 A1
(43) Pub. Date: Jul. 10, 2014

(54) TRACING OPERATIONS IN A CLOUD SYSTEM

(71) Applicants: Kok Leong Ryan Ko, Singapore (SG); Peter Jagadpramana, Singapore (SG); Bu Sung Lee, Singapore (SG)

(72) Inventors: Kok Leong Ryan Ko, Singapore (SG); Peter Jagadpramana, Singapore (SG); Bu Sung Lee, Singapore (SG)

(21) Appl. No.: 14/130,758

(22) PCT Filed: Jul. 12, 2011
(86) PCT No.: PCT/US2011/043679

§ 371 Date: Jan. 3, 2014

(51) Int. Cl. G06F 9/455

(52) U.S. Cl. CPC G06F 9/45533
USPC 718/1

(57) ABSTRACT

An apparatus and a related method to track operations on a cloud system are provided. A processor may execute at least one virtual machine that emulates an independent computer apparatus. A module may receive a first record generated by the at least one virtual machine. The first record may comprise at least one attribute associated with an operation occurring in a virtual machine. The module may also generate a second record having attributes corresponding to some of the attributes in the first record.

### BACKGROUND

Cloud computing has increased in popularity in recent years as more applications and data services are being managed remotely on a server rather than locally on a client. For example, when a user wishes to create a document, a suitable application running on the server displays the document created by the user on the client web browser. Memory is allocated on a client device to display application data on a screen, but calculations are carried out by one or more remote computers on a network. Moreover, all files are stored remotely on cloud servers, including files that may contain sensitive or personal data.

### BRIEF DESCRIPTION OF THE DRAWINGS

FIG. 1 illustrates an example of a cloud system in accordance with aspects of the application;

FIG. 2 is an example of a cloud server in accordance with aspects of the application;

FIG. 3 is an example of a virtual machine in accordance with aspects of the application;

FIG. 4 is a flow diagram of an example of a method of storing information associated with an operation;

FIG. 5 is a functional diagram of an example of a virtual machine and a computer apparatus in accordance with aspects of the application;

FIG. 6 is a functional diagram of another example of a virtual machine and a computer apparatus in accordance with aspects of the application; and

FIGS. 7A-B disclose an example of a set of records in accordance with aspects of the application.

### DETAILED DESCRIPTION

While cloud computing has been praised for promoting scalability and simplifying maintenance, it has also been criticized for potential security risks including exposing information to unlawful monitoring and theft. Aspects of the application provide techniques for tracking operations in a cloud system. In one aspect, a computer apparatus may execute at least one virtual machine that emulates an independent computer apparatus. In another aspect, operations are intercepted within the computer apparatus and virtual machines executing therein. The operations may be file operations, such as a file read, a file write, a file delete, a file create, or a file transfer. These intercepted operations may be recorded so as to create a trail of file operations that may be utilized to determine file activity.

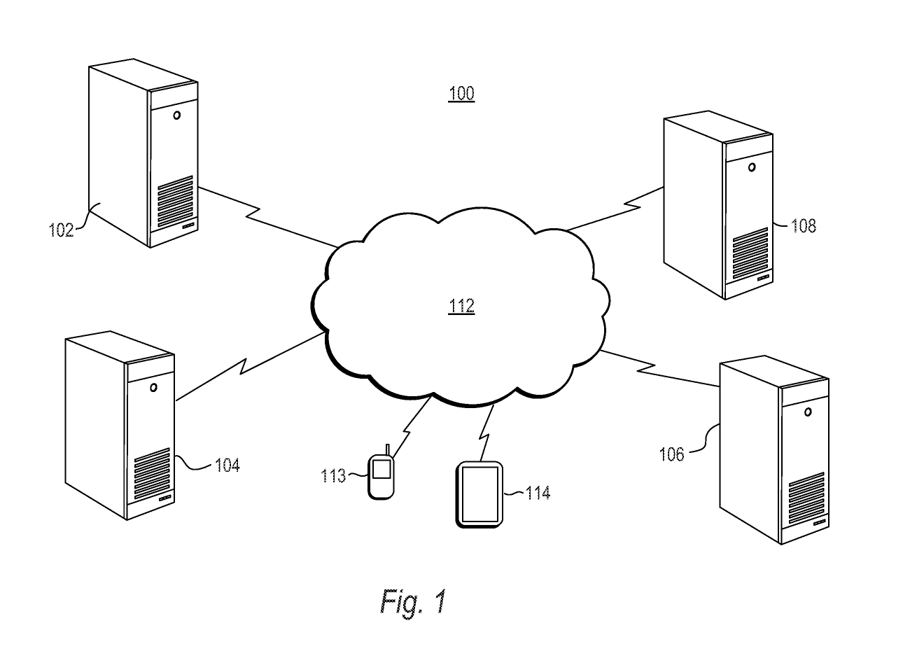

FIG. 1 presents a schematic diagram of an illustrative cloud system 100 depicting various computing devices used in a networked configuration. For example, FIG. 1 illustrates a plurality of computers 102, 104, 106 and 108. Each computer may be a node of the cloud and may comprise any device capable of processing instructions and transmitting data to and from other computers, including a laptop, a full-sized personal computer, a high-end server, or a network computer lacking local storage capability. Moreover, a node may comprise a mobile phone 113 or a mobile device 114 capable of wirelessly exchanging data with a server. Mobile device 114 may be a wireless-enabled PDA or a tablet PC.

The computers or devices disclosed in FIG. 1 may be interconnected via a network 112, which may be a local area network (“LAN”), wide area network (“WAN”), the Internet, etc. Network 112 and intervening nodes may also use various protocols including virtual private networks, local Ethernet networks, private networks using communication protocols proprietary to one or more companies, cellular and wireless networks, instant messaging, HTTP and SMTP, and various combinations of the foregoing. Although only a few computers are depicted in FIG. 1, it should be appreciated that a typical cloud system can include a large number of interconnected computers.

As noted above, each computer or device shown in FIG. 1 may be at one node of cloud system 100 and capable of directly or indirectly communicating with other computers or devices of the system. For example, computer 104 may be a cloud server capable of communicating with a client computer such that computer 104 uses network 112 to transmit information for presentation to a user. Accordingly, computer 104 may be used to generate requested information for display via, for example, a web browser executing on computer 102. Any one of the computers 102, 104, 106, and 108 may also comprise a plurality of computers, such as a load balancing network, that exchange information with different nodes of a network for the purpose of receiving, processing, and transmitting data to multiple client computers. In this instance, the client computers will typically still be at different nodes of the network than any of the computers comprising computers 102, 104, 106 and 108.

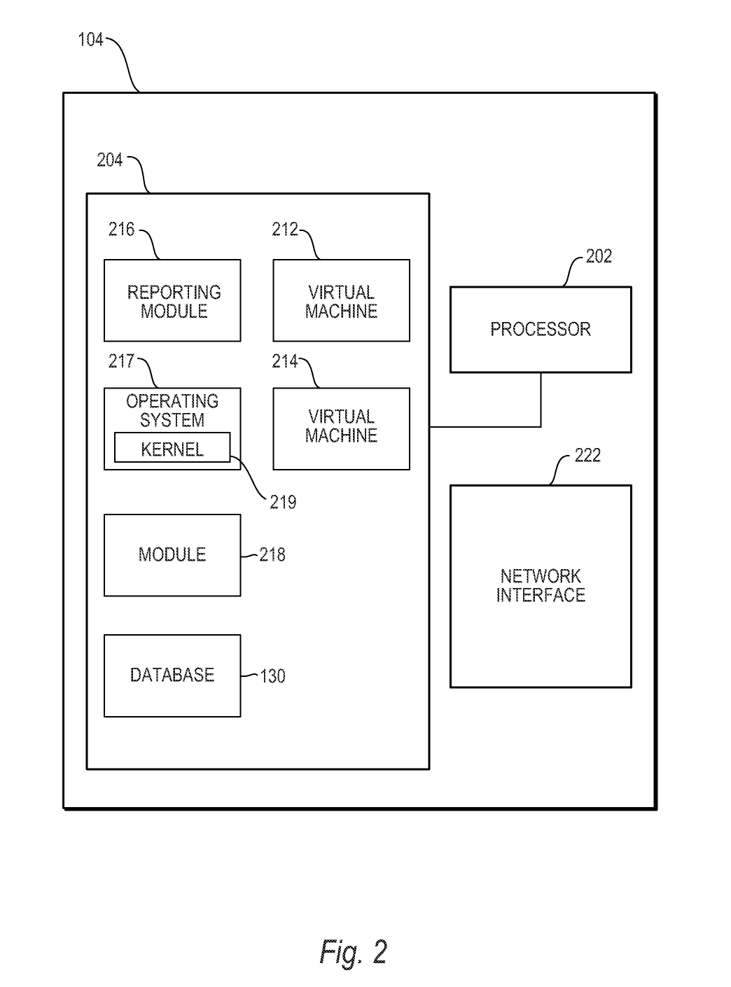

FIG. 2 presents a close up illustration of computer 104. In the example of FIG. 2, computer 104 is a computer apparatus configured as a cloud server and may contain a processor 202, memory 204, and other components typically present in a computer. Other components may include a display (e.g., a monitor having a screen, a touch-screen, a projector, a television, a computer printer or any other electrical device that is operable to display information), and a user input (e.g., a mouse, keyboard, touch-screen or microphone). Memory 204 of computer 104 may store information accessible by processor 202, including instructions, which may be executed by the processor 202, and a database 130, containing data that may be retrieved, manipulated, or stored by the processor. The memory 204 may be of any type or device capable of storing information accessible by the processor, such as a hard-drive, ROM, RAM, CD-ROM, flash memories, write-capable or read-only memories. The processor 202 may comprise any number of well known processors or a dedicated controller for executing operations, such as an ASIC. Systems and methods may include different combinations of the foregoing, whereby different portions of the instructions and data are stored on different types of media.

Network interface 222 of computer 104 may comprise circuitry suitable for communication with other computers or devices on the cloud system 100. Network interface 222 may be an Ethernet interface that implements a standard encompassed by the Institute of Electrical and Electronic Engineers (IEEE), standard 802.3. In another example, network interface 222 may be a wireless fidelity (“Wi-Fi”) interface in accordance with the IEEE 802.11 suite of standards. It is understood that other standards or protocols may be utilized, such as Bluetooth or token ring.

Although FIG. 2 functionally illustrates the processor 202 and memory 204 as being within the same block, it will be understood that the processor and memory may actually comprise multiple processors and memories that may or may not be stored within the same physical housing. For example, any one of the memories may be a hard drive or other storage media located in a server farm of a data center. Accordingly, references to a processor, computer, or memory will be understood to include references to a collection of processors or computers or memories that may or may not operate in parallel. Furthermore, database 130 may be at a location physically remote from, but still accessible by, the processor 202.

The instructions disclosed herein may be any set of instructions to be executed directly (such as machine code) or indirectly (such as scripts) by processor 202. For example, the instructions may be stored as computer code on a computer-readable medium. In that regard, the terms “instructions,” “programs,” or “modules” may be used interchangeably herein. The instructions may be stored in object code format for direct processing by the processor, or in any other computer language including scripts or collections of independent source code modules that are interpreted on demand or compiled in advance. However, it will be appreciated that examples herein can be realized in the form of software, hardware, or a combination of hardware and software. Functions, methods and routines of the instructions are explained in more detail below.

The capacity of servers on the cloud is typically utilized through a technique known as virtualization. Virtualization allows a processor to emulate at least one independent computer apparatus in accordance with instructions, such as virtual machine instructions 212 and 214. Operations on a cloud system may occur on a physical computer apparatus or on a virtual machine. Each virtual machine may have its own operating system, storage device, and network resources. A separate portion of memory 204 and network interface 222 may be dedicated to each virtual machine. FIG. 2 depicts two virtual machine instructions 212 and 214 that may be used to emulate two separate computers. While two virtual machines are depicted in FIG. 2, a cloud server may execute multiple virtual machines dedicated to different client requests on the cloud network. For example, while the remaining portions of computer 104 may serve the requests of computer 102 of cloud system 100, virtual machine 212 may simultaneously serve the requests of another client computer, such as computer 108. Each virtual machine may serve additional client requests simultaneously and may act as an independent computer apparatus with an operating system different than that of the physical computer apparatus or of other virtual machines.

Reporting module 216 may receive and consolidate information associated with operations occurring in a virtual machine. Kernel 219 may be any set of instructions suitable for managing the resources of computer 104 and allowing other programs to utilize those resources. Kernel 219 may be a central component of operating system 217 (e.g., UNIX, LINUX, Windows etc.). Module 218 may be instructions that interface with kernel 219 to intercept system calls or interrupts, such as file operations, executing on computer 104. The file operations may be any process associated with a file on computer 104 (e.g., read, write, copy, rename etc.). Module 218 may be a loadable kernel module (“LKM”) or a device driver containing instructions that extend kernel 219.

Reporting module 216 may also store records associated with operations occurring on computer 104 or virtual machines 212 and 214 in database 130. Database 130 is not limited by any particular data structure and may be stored in computer registers, in a relational database as a table having a plurality of different fields and records, XML documents, or flat files. The data may also be formatted in any computer-readable format. The data may comprise any information sufficient to identify the relevant information, such as numbers, descriptive text, proprietary codes, or references to data stored in other areas of the same memory or different memories (including other network locations).

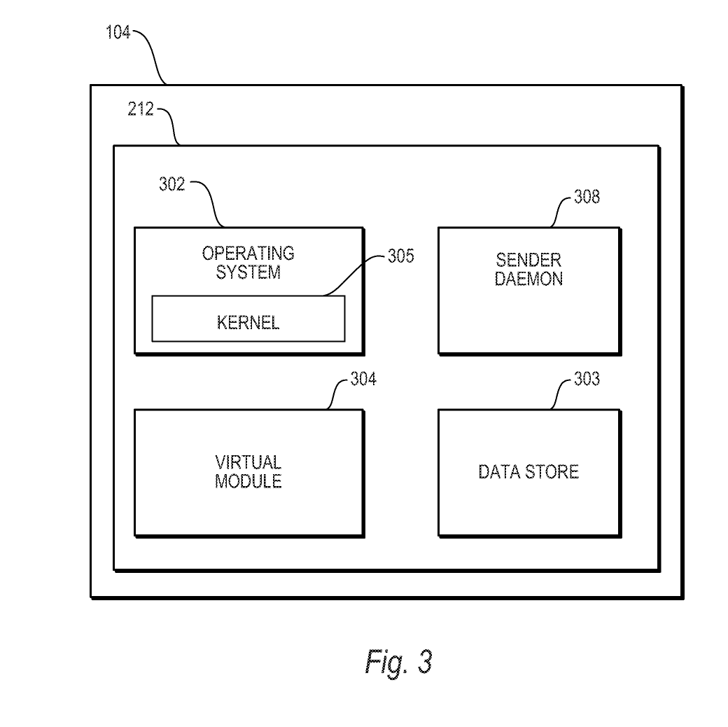

Referring to FIG. 3, one example of a virtual machine is provided. While FIG. 3 focuses on virtual machine 212 for ease of illustration, it is understood that virtual machine 214 or any other co-existing virtual machine of computer 104 may include features similar to virtual machine 212 of FIG. 3. Virtual machine 212 may have an operating system 302, a kernel 305, a virtual module 304 to intercept operations occurring in the virtual machine, and a data store 303 to store information associated with those operations. Data store 303 may be configured similarly to database 130 of computer 104. Virtual machine 212 may also include sender daemon instructions 308 to transmit information to the physical computer apparatus, computer 104. If virtual machine 212 is assigned to handle a specific client request, virtual module 304 may intercept system calls pertaining to that request and store certain attributes associated with the operation. As with module 218, virtual module 304 may be an LKM or device driver extension of kernel 305. In one example, virtual module 304 intercepts file operations within virtual machine 212 and records certain details associated with the file operation.

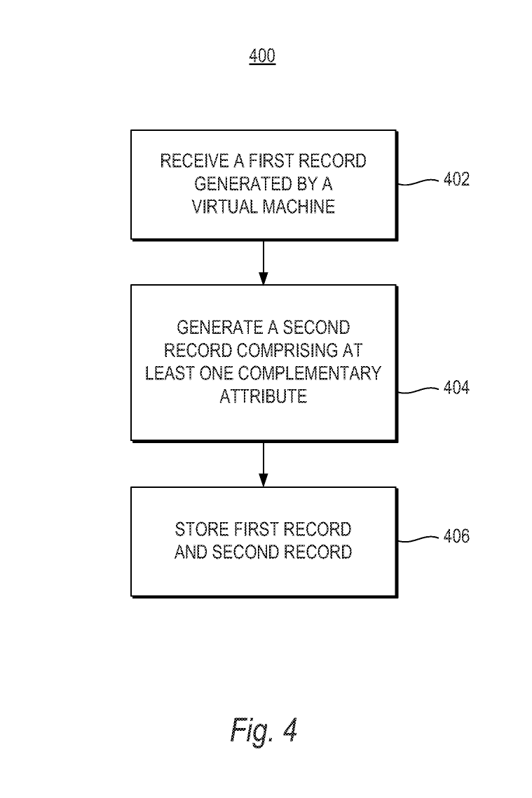

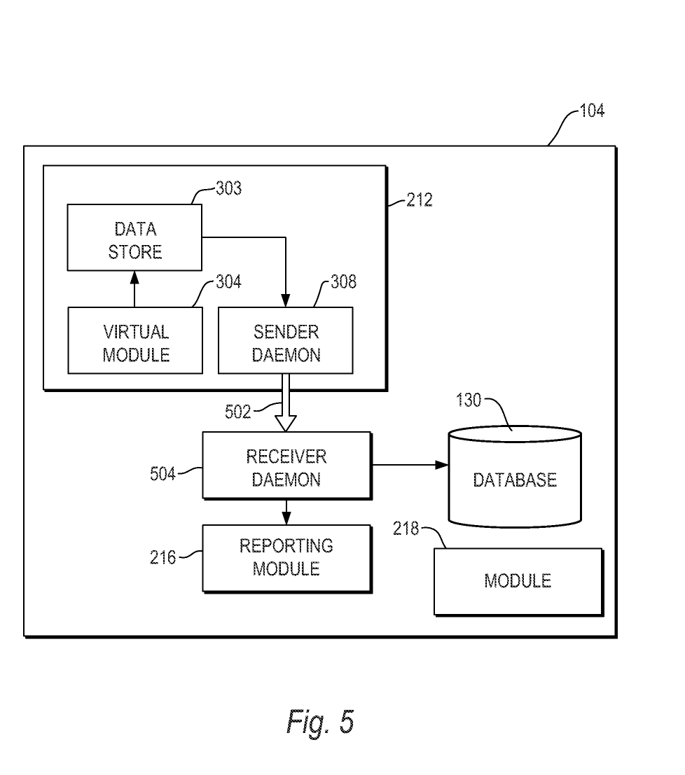

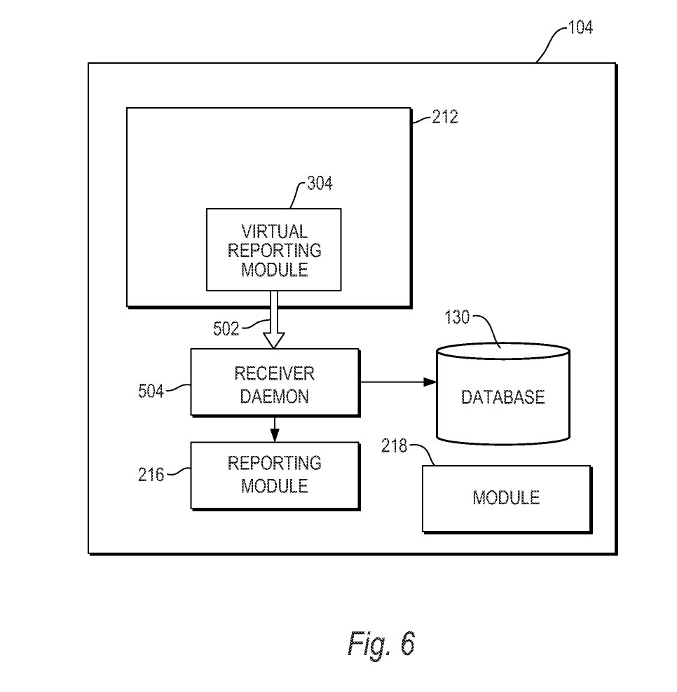

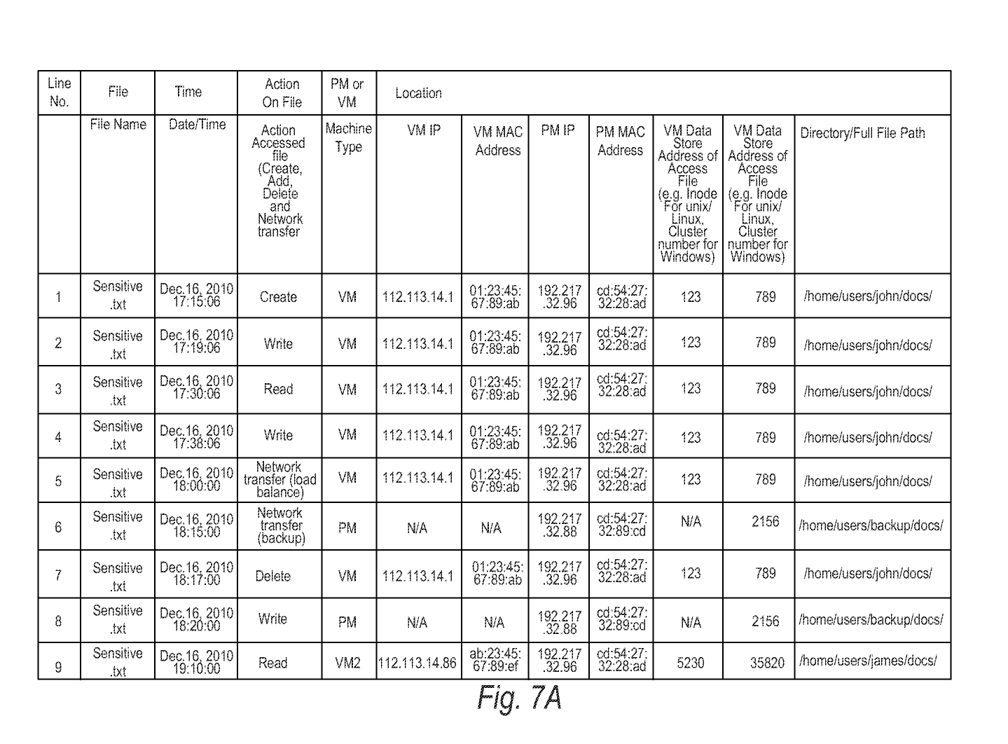

One working example of the system and method is shown in FIGS. 4-6. In particular, FIG. 4 illustrates a flow diagram of a process to record certain operations on a physical and virtual computer apparatus. FIGS. 5-6 illustrate aspects of the virtual machine and the physical computer apparatus. The actions shown in FIGS. 5-6 will be discussed below with regard to the flow diagram of FIG. 4.

Referring to FIG. 4, one example of a method 400 of tracing operations is provided. As shown in block 402, a first record generated by a virtual machine may be received. The first record may comprise at least one attribute associated with an operation occurring in a virtual machine, such as virtual machine 212. A virtual machine may generate a record when a system call is invoked within the virtual machine. The system call may be invoked by a file operation (e.g., a file create, a file write, a file deletion, a file rename, etc.). As shown in FIG. 5, virtual module 304 may intercept the system call and log a record associated with the operation in data store 303. The data store 303 may contain records associated with every operation, such as file operations, occurring on a virtual machine. Each record may contain attributes associated with the operation. For example, the record may include a filename of a file that was accessed during a file operation in the virtual machine, the date/time of the access, the virtual machine media access control (“MAC”) address, the virtual machine internet protocol (“IP”) address, an operation applied to a file, or the address of an accessed file on the virtual machine (e.g., mode number for Linux or cluster number for Windows).

FIG. 5 illustrates sender daemon instructions 308 retrieving a record from the data store 303 and transmitting the record to the physical computer apparatus via communication channel 502. Receiver daemon instructions 504 may be instructions that configure the processor to receive messages from a virtual machine. Communication channel 502 may be a virtual serial link, such as Citrix Xen V4V or a VMWare virtual machine communication interface (“VMCI”) enabled for inter-domain communication. FIG. 6 shows an alternate example of a virtual machine. In the example of FIG. 6, virtual module 304 transmits a record to a receiver daemon 504 instantaneously. Receiver daemon 504 may forward the record to reporting module 216 in computer 104. As noted above, reporting module 216 may consolidate all the records received from the virtual machine.

In block 404 of FIG. 4, a second record may be generated. The second record may comprise at least one complementary attribute such that the complementary attribute of the second record corresponds to at least one attribute in the first record. Reporting module 216 may generate the new record containing the corresponding attributes. For example, the generated record may contain the corresponding location of the file in the physical computer apparatus, the corresponding MAC address, or the corresponding IP address. In block 406, the first record and the second record may be stored in, for example, database 130.

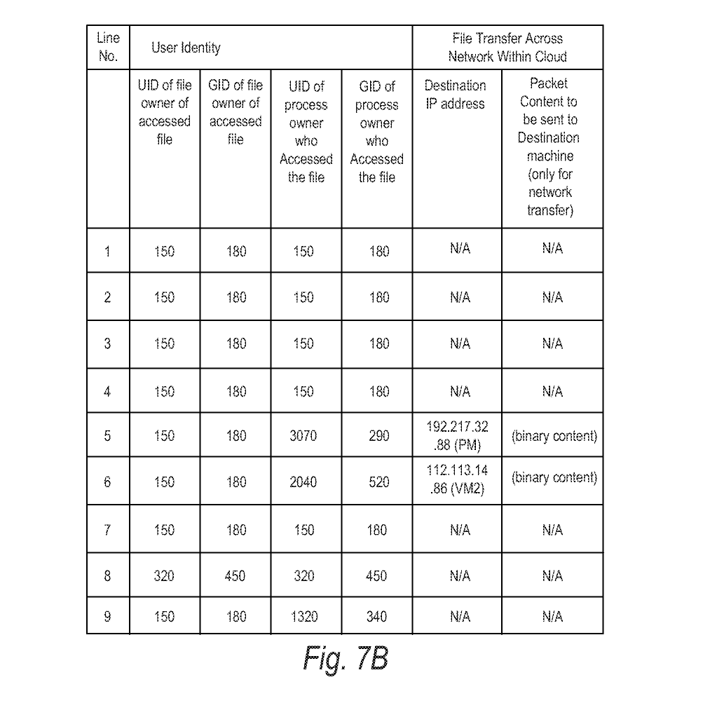

FIGS. 7A-B depict an illustrative set of records associated with file operations. FIG. 7A shows the first twelve fields of each illustrative record and FIG. 7B shows the remaining seven fields. The records depicted in FIGS. 7A-B may be stored in database 130. The first record contains information pertaining to a file named “sensitive.txt” created on a virtual machine. As shown in FIG. 7A, the fields may contain different attributes of the virtual machine (e.g., IP address, MAC address, file address etc.) and the corresponding values of in the physical computer apparatus. As shown in FIG. 7B, the illustrative records may even contain user information, such as userid or groupid. Record six represents a network transfer operation of the file “sensitive.txt” occurring on the physical computer apparatus only. Record nine represents a read operation of the file “sensitive.txt” occurring on a second virtual machine.

The above-described system enables the tracking of operations, such as file operations, occurring on the cloud network. In this regard, users may have greater confidence that sensitive files stored in the cloud can be traced in case of theft or loss of data.

Although the application herein has been described with reference to particular examples, it is to be understood that these examples are merely illustrative of the principles and applications of the disclosure. It is therefore to be understood that numerous modifications may be made to the illustrative examples and that other arrangements may be devised without departing from the spirit and scope of the application as defined by the appended claims. Furthermore, while particular processes are shown in a specific order in the appended drawings, such processes are not limited to any particular order unless such order is expressly set forth herein. Rather, various steps can be handled in a different order or simultaneously, and steps may be omitted or added.

1. A computer apparatus to trace operations in a cloud system, the computer apparatus comprising:
a processor, the processor executing at least one virtual machine, the at least one virtual machine emulating an independent computer apparatus;
a module to:
receive a first record generated by the at least one virtual machine, the first record comprising at least one attribute, the at least one attribute being associated with an operation occurring in the at least one virtual machine;
generate a second record, the second record comprising at least one complementary attribute such that the at least one complementary attribute corresponds to the at least one attribute; and
store the first record and the second record in a storage.

2. The computer apparatus of claim 1, wherein the operation occurring in the at least one virtual machine is a file operation executed upon a file in the at least one virtual machine.

3. The computer apparatus of claim 2, wherein the at least one attribute is a location of the file in the at least one virtual machine; and the at least one complementary attribute is a corresponding location of the file in the computer apparatus.

4. The computer apparatus of claim 2, wherein the at least one attribute is an internet protocol address of the at least one virtual machine and the at least one complementary attribute is a corresponding internet protocol address of the computer apparatus.

5. The computer apparatus of claim 1, wherein the virtual machine further comprises a virtual module to intercept operations occurring in the virtual machine.

6. The computer apparatus of claim 1, further comprising receiving daemon instructions to receive the first record generated by the at least one virtual machine; and to forward the first record to the module.

7. The computer apparatus of claim 6, wherein the virtual machine further comprises sender daemon instructions to forward the first record from the virtual machine to the receiving daemon.

8. A computer apparatus to trace operations in a cloud system, the computer apparatus comprising:
a processor, the processor executing at least one virtual machine, the at least one virtual machine emulating an independent computer apparatus;
a module to:
receive a first record generated by the at least one virtual machine, the first record comprising at least one attribute, the at least one attribute being associated with a file operation occurring in the at least one virtual machine;
generate a second record, the second record comprising at least one complementary attribute such that the at least one complementary attribute corresponds to the at least one attribute; and
store the first record and the second record in a storage.

9. The computer apparatus of claim 8, wherein the at least one attribute is a location of the file in the at least one virtual machine; and the at least one complementary attribute is a corresponding location of the file in the computer apparatus.

10. The computer apparatus of claim 8, wherein the at least one attribute is an internet protocol address of the at least one virtual machine and the at least one complementary attribute is a corresponding internet protocol address of the computer apparatus.

11. The computer apparatus of claim 8, wherein the virtual machine further comprises a virtual module to intercept operations occurring in the virtual machine.

12. The computer apparatus of claim 8, further comprising receiving daemon instructions to receive the first record generated by the at least one virtual machine; and to forward the first record to the module.

13. The computer apparatus of claim 12, wherein the virtual machine further comprises sender daemon instructions to forward the first record from the virtual machine to the receiving daemon.

14. A method to track operations in a cloud system, the method comprising:
receiving, using a processor, a first record generated by at least one virtual machine, the first record comprising at least one attribute, the at least one attribute being associated with an operation occurring in the at least one virtual machine;
generating, using the processor, a second record, the second record comprising at least one complementary attribute such that the at least one complementary attribute corresponds to the at least one attribute; and
storing, using the processor, the first record and the second record in a storage.

15. The method of claim 14, wherein generating the first record comprises:
intercepting, using the processor, operations occurring in the virtual machine; and
forwarding, using the processor, the first record from the virtual machine to a module to generate the second record.
